(19) United States
(12) Patent Application Publication
(10) Pub. No.: US 2008/0143679 A1
(43) Pub. Date: Jun. 19, 2008

(54) METHODS, DEVICES, AND USER INTERFACES INCORPORATING A TOUCH SENSOR WITH A KEYPAD

(75) Inventors: ROGER W. HARMON, CRYSTAL LAKE, IL (US); ROGER W. ADY, CHICAGO, IL (US); HAROLD J. GORENZ, LISLE, IL (US); PAUL M. PIERCE, GRAYSLAKE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/612,132

(22) Filed: Dec. 18, 2006

(51) Int. Cl. G06F 3/041

(52) U.S. Cl. 345/173

(57) ABSTRACT

Disclosed are devices, user interfaces and methods thereof, that include a touch sensitive surface configured to receive user input, the touch sensitive surface collocated with at least a portion of the keypad and disposed proximal keycaps corresponding to the portion of the keypad. A track of a particular shape is superimposed on the keycaps of the portion of the keypad collocated with the touch sensitive surface, the particular shape of the track configured to direct user input along the touch sensitive surface. In one embodiment, the track is curved and the finger of a user may be guided along the track. For example, a tactile feature of the track may be a height difference between the track and the keycaps. In one embodiment, the particular shape of the track can be configured to direct user input to the touch sensitive surface for scrolling through a list displayed on the display.

### FIELD

Disclosed are devices, user interfaces and methods thereof, that include a touch sensitive surface configured to receive user input, and more particularly, devices, user interfaces, and methods that include a touch sensitive surface collocated with at least a portion of a keypad and disposed proximal keycaps corresponding to the portion of the keypad.

### BACKGROUND

The makers of mobile communication devices, including those of cellular telephones, are increasingly adding functionality to their devices. For example, cellular telephones include features such as still and video cameras, video streaming, two-way video calling and music playback features such as MP3. While there is a trend toward the inclusion of more features and improvements for current features, there is also a trend toward smaller mobile communication devices. As mobile communication device technology has continued to improve, the devices have become increasingly smaller. Therefore, there may less surface area for placement of user interface components as manufacturers continue to add features and reduce their products' size.

Mobile users are increasingly spending time on their mobile communication devices. With the mobile communication devices' increased functionality, the more time users spend navigating menus and lists stored in their mobile communication devices. When placing a telephone call, for example, a user will scroll through a contact list stored in the memory of the mobile communication device. When using the device as an MP3 player, the user will scroll through a catalog of audio tracks stored in the memory. To scroll through a list, a user will hold down or repeatedly press a navigation key. However, a set of the navigation keys may occupy valuable surface area. Moreover, a set of navigation keys may not provide a tactile guide to the user of the keys for input since the navigation keys are typically the same height as an input keypad, such as a QWERTY keypad or conventional cell phone keypad.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts an embodiment of an electronic device in particular a mobile communication device including a touch sensitive track collocated with a functional keypad;

FIG. 2 shows a closer look at a touch sensitive surface track superimposed on the keycaps of the portion of the keypad collocated with the touch sensitive surface;

FIG. 3 is a cut away side view of the keypad, taken along a center line, through for example keys 2, 5 and 8;

FIG. 4 illustrates that the track may have a particular shape configured to direct user input to the touch sensitive surface for scrolling through a list depicted on the display such as a contact list; and

FIG. 5 is a flowchart of a method of an electronic device including switching between a functional keypad collocated with the touch sensitive surface track interface.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

It would be beneficial if navigation functionality were collocated for example on a keypad of an electronic device, and more particularly a mobile communication device. In this way surface area otherwise allocated for navigation keys may be reallocated. Moreover, it would be beneficial were there a tactile guide to assist the user in providing navigation input.

Disclosed are devices, user interfaces and methods thereof, that include a touch sensitive surface configured to receive user input, the touch sensitive surface collocated with at least a portion of the keypad and disposed proximal keycaps corresponding to the portion of the keypad. A track of a particular shape is superimposed on the keycaps of the portion of the keypad collocated with the touch sensitive surface, the particular shape of the track configured to direct user input along the touch sensitive surface. In one embodiment, the track is curved and the finger of a user may be guided along the track. For example, a tactile feature of the track may be a height difference between the track and the keycaps.

In one embodiment, the particular shape of the track can be configured to direct user input to the touch sensitive surface for scrolling through a list displayed on the display. For example, the track can include a first end and a second end and the list can include a top and a bottom. The user input near the first end of the track can produces scrolling toward the top of the list and user input near the second end of the track produces scrolling toward the bottom of the list. Moreover, scrolling speed may increase with proximity to an end of the track.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

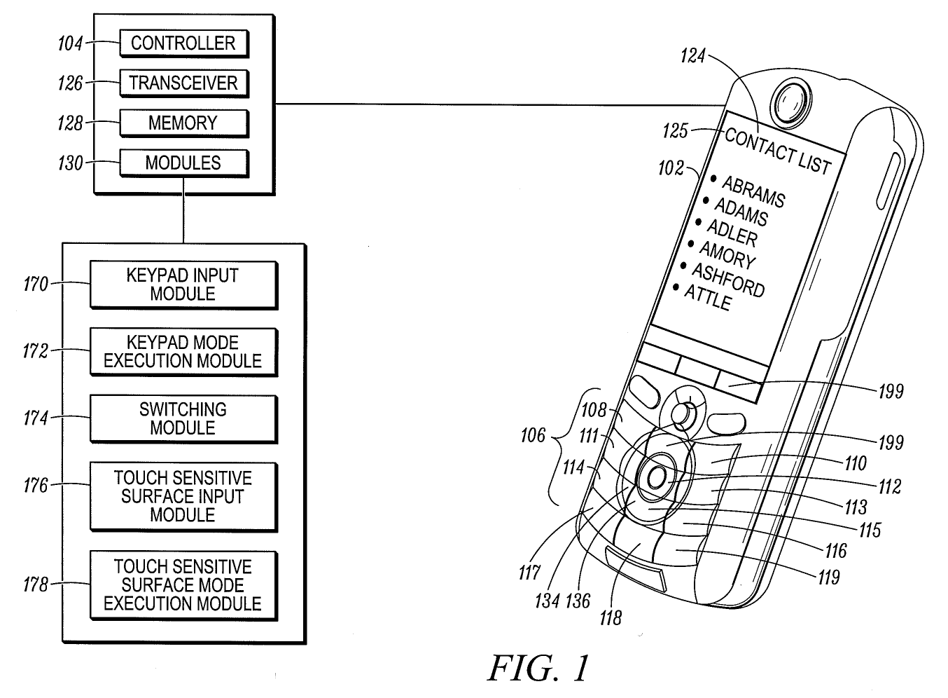

FIG. 1 depicts an embodiment of an electronic device, in particular a mobile communication device 102 including a touch sensitive track collocated with a functional keypad. The device can include a controller 104 and a keypad 106 coupled to the controller and configured to receive user input, the keypad having a plurality of keycaps 108, 109, 110, 111, 112, 113, 114, 115, 116, 117, 118, and 119. A keypad 106 may be a QWERTY keypad and/or the keypad 106 may include fewer or more keycaps.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

An electronic device 102 that is a mobile communication device can include a display 124, transceiver 126, memory 128 and modules 130. On the display 126, a contact list or portion of a contact list 125 is shown. Particular functions of the device may be available for execution through keypad input. Other particular functions of the electronic device may be available through touch sensitive surface input.

Modules 130 can include a keypad input receiving module 170 for receiving user input to a keypad of the electronic device, and a keypad function executing module for executing a function of a mode for keypad input 172 of the electronic device according to the user input to the keypad. Modules 130 can further include a keypad/touch sensitive surface switching module 174 for switching between a mode for keypad input and a mode for touch sensitive surface input. Moreover, the modules 130 can include a touch sensitive surface input module 176 for receiving user input to a touch sensitive surface collocated with at least a portion of the keypad of the electronic device, and a touch sensitive surface executing module 178 for executing a function of a mode for touch sensitive surface input of the electronic device according to the user input to the touch sensitive surface.

The modules 130 and others can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

FIG. 1 further illustrates a touch sensitive surface 134 that can be coupled to the controller 104 and configured to receive user input, the touch sensitive surface 134 collocated with at least a portion of the keypad 106. A track 136, of a particular shape, in this example, circular, can be superimposed on the keycaps 108-116 that are a portion of the keypad 106 that is collocated with the touch sensitive surface 134. The particular shape of the track 136 is configured to direct user input along the touch sensitive surface 134. The track 136 can provide information to the user as to the location of the active area for a capacitive or resistive touch sensor of the touch sensitive surface 134 and a selection function, in one embodiment, placed at the center of the touch sensitive surface 134. The selection function may be located off-center in relation to the touch sensitive surface in another embodiment. For example, the selection function may be activated at one or more locations at or near an outer edge of the touch sensitive surface.

The touch sensitive surface 134 collocated with at least a portion of the keypad 106 can have any particular shape. The track 136 superimposed on the keycaps of the keypad 106 can have a corresponding shape configured to direct user input along the touch sensitive surface 134. While FIG. 1 illustrates a track 136 having a circular shape, the shape may be a linear shape such as a straight line or an arc that forms a partial circle. In another embodiment, the particular shape may be linear, for example, spanning diagonally across the keypad 106. The user interface of the track 136 may include a touch sensitive surface 134 configured to detect a sliding motion of a user's finger. The touch sensitive surface 134 can be provided in any manner, such a capacitive touch surface or a resistive touch surface. While the track 136 shown is circular, the geometry of the feature could be oval, elliptical and any shape that can correspond with intended motion over the touch sensor's active area. In this way, a navigation user interface can be collocated with the keypad 106 and valuable surface area of the electronic device 102 can be reallocated, if desired.

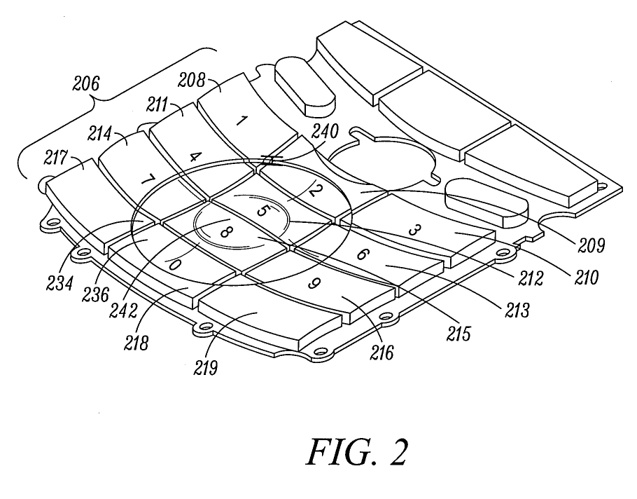

FIG. 2 shows a closer look at the track 236 of a particular shape corresponding to the shape of the touch sensitive surface 234 and superimposed on the keycaps 208-219 of the portion of the keypad 206 collocated with the touch sensitive surface 234. A tactile feature that may act as a tactile guide of the track 236 can be superimposed on the keycaps 208-219 such as a height difference 240 between the track and the keycaps. The height difference 240 may be for example 0.2 mm or any height that is configured to direct user input along the touch sensitive surface 234. Instead of a height difference or in addition to it, there may be a tactile material defining the track 236 that can be tactilely distinguished from at least one tactile material of the keycaps 208-219. This tactile guide may be either a physically raised surface or a lowered surface, different textures, different surface finishes, for example, the material defining the track 236 may have a slippery texture, and any combination of such features. It is understood that any manner in which to distinguish the touch sensitive surface collocated with the keypad is within the scope of this discussion.

In the example illustrated in FIG. 2, an additional tactile feature 242 is shown to be superimposed on a particular key of the keypad and configured to designate a particular functionality. The keypad 206 includes a “5 key” and an “8 key.” A tactile feature 242 superimposed on both keys may be a raised bump superimposed on a keycap of the 5 key and the 8 key. Alternatively, the tactile feature can be on one key, such as the 5 key 112 (see FIG. 1) of keypad 106. It is understood that one or more additional tactile features may be in any suitable position. A function of an additional tactile feature can be for example, a “select” switch type function of the capacitive or resistive sensor.

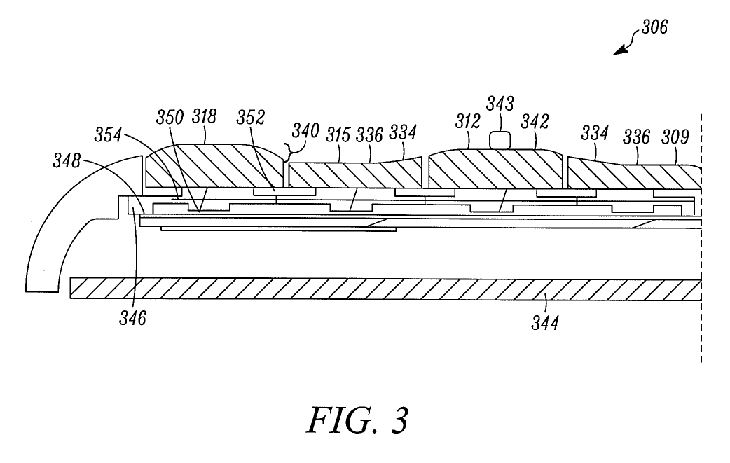

FIG. 3 is a cut away side view of the keypad 306, taken along a center line, through for example keys 2, 5, 8, and 0. A tactile feature 342 superimposed on, for example, the 5 key can be a raised bump, protrusion or indentation. The height differential 340 can be any height that is configured to direct user input along the touch sensitive surface 334. FIG. 3 illustrates an example of geometry that further directs, constrains and/or guides the motion of a user's finger.

The keypad 306 can include components such as a substrate 344. A web-less, semi-web-less or membrane type Bell-keypad with a tactile feature can guide a user's use of a capacitive or resistive touch sensor that is located in, on top, or below a fully functional and separately distinguishable keypad 306. The keyboard or keypad PCB 346 may be proximal a metal or MYLAR dome 348 and posts 350. The keypad base or web 352 may be proximal to the keycaps 309, 312, 315 and 318 or outer keypad 306. A touch sensitive surface 334, such as a capacitive sensing layer 354 may be located in, above or below the keypad web 352 but also could be located on the keypad PCB 346 or any other suitable location. A resistive sensing layer may be similarly located in, above, or below the keypad but could also be located on the keypad. Any other type of touch sensitive layer may be positioned in, above or below the keypad as well.

The physical features that create the track 336 provide both visual and non-visual cues. Accordingly the touch sensor functions, for example, a music playback function of the electronic device such as play, pause, stop, volume change, and/or song skip, may be used on-the-go in darkness, from a holster, or within a coat pocket, without requiring the user to stop and look at the electronic device. The protrusion 342 may double as a reference nib 343 for phone keypad mode and a location center select for touch sensor mode. Accordingly, the keypad may feel and operate as a normal keypad.

The track 336 may include additional features to distinguish it from the keypad 306. For example, where there is steep change in height 340, lighting may be provided to illuminate the edge of the track 336 during touch sensor or track user interface mode. That is, for example, an edge of the track 336, or the entire track, can be illuminated while the user interface is activated. It is understood that other distinguishing features are possible as well, such as coloring the track, lighting the protrusion 342, and coating the track with a tactile surface distinguishable from the other portion of the keypad 306.

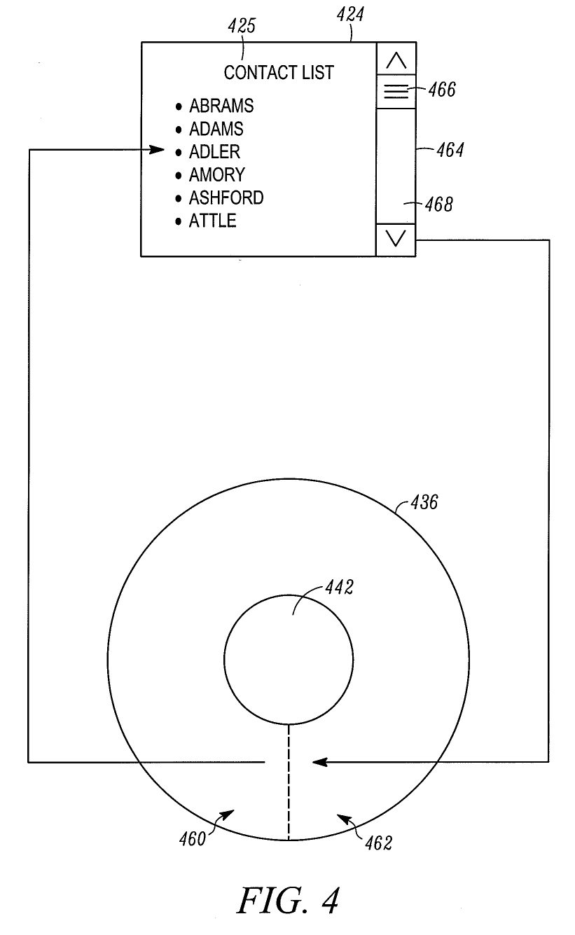

FIG. 4 illustrates that the track 436 may have a particular shape configured to direct user input to the touch sensitive surface for scrolling through a list depicted on the display 424, such as a contact list 425. In one embodiment, the circular track 436 can have a first end 460 and a second end 462. A track having a different shape, such as linear shape may have a first end and a second end also. The contact list 425 can have a top and a bottom. The scroll bar 464 may show the top of the list 466 and the bottom of the list 468.

In one embodiment, user input near the first end 460 of the track 436 produces scrolling toward the top of the list 466. User input near the second end of the track 462 can produce scrolling toward the bottom of the list 468. In yet another embodiment, scrolling speed can increase with proximity to an end of the track, the first end 460 and/or the second end 462. In this manner, the scrolling control could resemble a boat throttle. Moreover, different types of scrolling control may be made available by the same track. That is, in one user interface mode, the boat throttle type of scrolling may be provided. In another user interface mode, a continuous sweep type of scrolling may be provided where the speed of the scrolling does not change based on position along the track 436. It is understood that the scrolling methods for the track can include all types of scrolling.

In the event that the display screen 424 is not visible, it may be desirable that an audio signal can be generated to indicate the list content. Audio signals that represent list content can be in the alternative or in addition to the visual display 424. For example, were the user to scroll through a song list, clips of songs may be provided as audio signals to represent the list content.

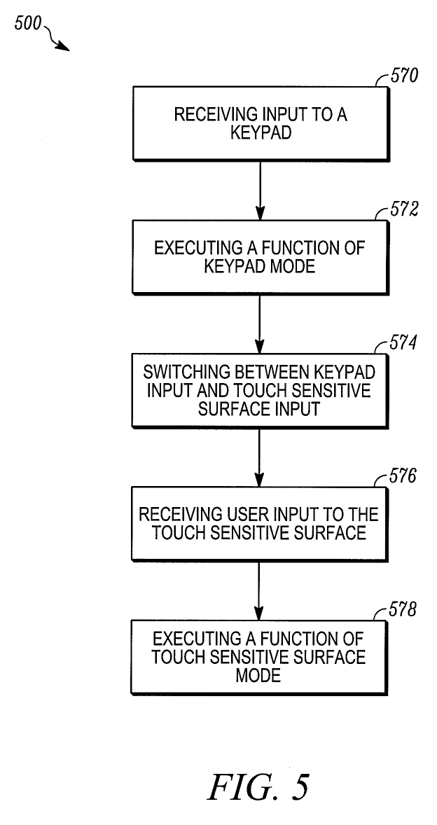

FIG. 5 is a flowchart of a method 500 of an electronic device 102 (see FIG. 1) including switching between a functional keypad collocated with the touch sensitive surface track interface. The method can include receiving user input to a keypad of the electronic device 570 in accordance with the keypad input receiving module 170 for receiving user input to a keypad of the electronic device. The method can also include executing a function of a mode for keypad input of the electronic device according to the user input to the keypad 572 and according to a keypad function executing module for executing a function of a mode for keypad input 172.

Switching between a mode for keypad input and a mode for touch sensitive surface input 574 may be provided according to a keypad/touch sensitive surface switching module 174 for switching between a mode for keypad input and a mode for touch sensitive surface input. To switch between modes, a user may activate a switch that is for example a soft key 199 (see FIG. 1), a menu item, or using contextual awareness. For example, the mobile communication device 102 may be programmed to actuate the touch sensor when the user initiates certain functions that are facilitated by the sensor such as selecting a ring tone or telephone number. Side keys could also be used to activate the touch sensor as well as using a combination of keys. It is understood that any manner in which to switch between using the touch sensor and the keypad is within the scope of this discussion. The method can then include receiving user input to a touch sensitive surface 576 collocated with at least a portion of the keypad of the electronic device in accordance with a touch sensitive surface input module 176 for receiving user input to a touch sensitive surface.

Additionally the method can include executing a function of a mode for touch sensitive surface input 578 of the electronic device according to the user input to the touch sensitive surface 134 (see FIG. 1). A touch sensitive surface executing 178 module can provide instructions for executing a function of a mode for touch sensitive surface input of the electronic device according to the user input to the touch sensitive surface. As discussed above, executing a function of the electronic device according to the user input to the touch sensitive surface can include scrolling through a list shown on the display device. Executing a function of the electronic device according to the user input to the touch sensitive surface can further include selecting an item of the list as described above.

The disclosed devices, user interfaces and methods thereof, that include a touch sensitive surface configured to receive user input collocated with at least a portion of the keypad and disposed proximal keycaps corresponding to the portion of the keypad may allow the surface area otherwise occupied by navigation keys to be reallocated. The disclosed track of a particular shape superimposed on the keycaps of the portion of the keypad collocated with the touch sensitive surface may beneficially provide a tactile guide to assist the user in providing navigation input.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device, comprising
a controller;
a keypad coupled to the controller and configured to receive user input, the keypad having a plurality of keycaps;
a touch sensitive surface coupled to the controller and configured to receive user input, the touch sensitive surface collocated with at least a portion of the keypad and disposed proximal keycaps corresponding to the at least a portion of the keypad; and
a track of a particular shape superimposed on the keycaps of the at least a portion of the keypad collocated with the touch sensitive surface, the particular shape of the track configured to direct user input along the touch sensitive surface.

2. The device of claim 1, wherein the track of a particular shape is a curved track.

3. The device of claim 1, wherein the keypad comprises a QWERTY keypad.

4. The device of claim 1, wherein the touch sensitive surface is capacitive.

5. The device of claim 1, wherein the track comprises a tactile feature superimposed on the keycaps.

6. The device of claim 5, wherein the tactile feature of the track comprises a height difference between the track and the keycaps.

7. The device of claim 5, wherein the keycaps comprise at least one tactile material and the tactile feature is configured to be tactilely distinguished from the at least one tactile material of the keycaps.

8. The device of claim 1, further comprising:
a tactile feature superimposed on a particular key of the keypad and configured to designate a select functionality.

9. The device of claim 8, wherein the keypad includes a 5 key and the tactile feature superimposed on a particular key is a raised bump superimposed on a keycap of the 5 key.

10. A user interface of an electronic device having a controller and a display, the user interface comprising:
a keypad coupled to the controller and configured to receive user input, the keypad having a plurality of keycaps;
a touch sensitive surface coupled to the controller and configured to receive user input, the touch sensitive surface collocated with at least a portion of the keypad and disposed proximal keycaps corresponding to the at least a portion of the keypad;
a track of a particular shape superimposed on the keycaps of the at least a portion of the keypad collocated with the touch sensitive surface, the particular shape of the track configured to direct user input to the touch sensitive surface for scrolling through a list displayed on the display.

11. The user interface of claim 10, wherein:
the track has a first end and a second end;
the list has a top and a bottom;
user input near the first end of the track produces scrolling toward the top of the list;
user input near the second end of the track produces scrolling toward the bottom of the list; and
scrolling speed increases with proximity to an end of the track.

12. The user interface of claim 10, wherein the track of a particular shape is a curved track.

13. The user interface of claim 10, wherein the touch sensitive surface is configured to detect a sliding motion.

14. The user interface of claim 10, wherein the touch sensitive surface is capacitive.

15. The user interface of claim 10, wherein the track comprises a tactile feature superimposed on the keycaps.

16. The user interface of claim 15, wherein the tactile feature of the track comprises a height difference between the track and the keycaps.

17. The user interface of claim 15, wherein the keycaps comprise at least one tactile material and the tactile feature is configured to be tactilely distinguished from the at least one tactile material of the keycaps.

18. The user interface of claim 10, wherein the track is illuminated while the user interface is activated.

19. A method of an electronic device, the method comprising:
receiving user input to a keypad of the electronic device;
executing a function of a mode for keypad input of the electronic device according to the user input to the keypad;
switching between a mode for keypad input and a mode for touch sensitive surface input;
receiving user input to a touch sensitive surface collocated with at least a portion of the keypad of the electronic device; and
executing a function of a mode for touch sensitive surface input of the electronic device according to the user input to the touch sensitive surface.

20. The method of claim 19, wherein the electronic device comprises a display device, and wherein executing a function of the electronic device according to the user input to the touch sensitive surface comprises scrolling through a list shown on the display device.

21. The method of claim 19, wherein executing a function of the electronic device according to the user input to the touch sensitive surface further comprises selecting an item of the list.
